(19) United States
(12) Patent Application Publication
(10) Pub. No.: US 2020/0356234 A1
(43) Pub. Date: Nov. 12, 2020

(54) Animation Display Method and Apparatus, Electronic Device, and Storage Medium

(71) Applicant: Beijing Kingsoft Internet Security Software Co., Ltd., Beijing (CN)

(72) Inventor: Yumeng Song, Beijing (CN)

(21) Appl. No.: 16/762,118

(22) PCT Filed: Jan. 22, 2019
(86) PCT No.: PCT/CN2019/072665

§ 371 Date: May 6, 2020

(30) Foreign Application Priority Data
May 22, 2018 (CN) 201810495766.X

(51) Int. Cl. G06F 3/0481; G06T 13/20; G06F 3/0482; G06F 3/16; G06F 3/0346

(52) U.S. Cl. CPC G06F 3/04815; G06T 13/205; G06F 3/0346; G06F 3/167; G06F 3/165; G06F 3/0482

(57) ABSTRACT

Disclosed are an animation display method and apparatus, an electronic device, and a medium. The method comprises: when it is detected that the user opens an input method interface, obtaining gravity sensing information of the user equipment; determining, according to the gravity sensing information, the displacement of a three-dimensional element in a first background scene on the input method interface; and displaying, according to the displacement of the three-dimensional element, an animation of the first background scene. Embodiments of the present application can improve the interest and interaction of the input of an input method.

The present application claims the priority to a Chinese patent application No. 201810495766.X filed with the China National Intellectual Property Administration on May 22, 2018 and entitled “Animation display method, apparatus, electronic device and storage medium”, which is incorporated herein by reference in its entirety.

### TECHNICAL FIELD

The present application relates to the field of computer application technology, and more particularly to an animation display method and apparatus, electronic device and storage medium.

### BACKGROUND

At present, in the process of using an input method, a user can install or change an input method theme, beautify an input method interface, and improve a visual effect of the input method interface. For example, a user can change a background picture of the input method interface to a favorite picture. In order to improve the user experience and increase interest of input, some input methods support the use of a video or a Graphics Interchange Format (GIF) file as the background picture of the input method interface. When a user clicks keyboard keys on the input method interface, a video or a GIF file is controlled to play or pause. However, no matter a picture or a video or a GIF file is used as the background picture of the input method interface, there are disadvantages of a single visual effect and a low interaction.

### SUMMARY

The embodiments of the present application provide an animation display method, apparatus, electronic device and storage medium. The interest and interaction of the input method input may be improved.

A first aspect of the present application provides an animation display method, including:

acquiring, when it is detected that the user opens an input method interface, a gravity sensing information of the user device;

determining, according to the gravity sensing information, a displacement of a three-dimensional element in a first background picture, wherein the first background picture is a background picture of the input method interface;

displaying, according to the displacement of the three-dimensional element, an animation of the first background picture.

Optionally, the method further includes:

displaying, when it is detected that the user clicks keys on the input method interface, an animation of the first background picture.

Optionally, step of displaying an animation of the first background picture when it is detected that the user clicks keys on the input method interface includes:

determining, when it is detected that the user clicks a target key among multiple keys on the input method interface, a display style of the first background picture corresponding to the target key;

displaying, according to the display style corresponding to the target key, an animation of the first background picture.

Optionally, the method further includes:

acquiring first identification information of the first background picture;

searching a first audio file corresponding to the first identification information from a preset voice library, the preset voice library includes a correspondence between identification information and an audio file;

playing, when an animation of the first background picture is displayed, the first audio file.

Optionally, the method further includes:

determining a first display duration of the animation of the first background picture;

searching a second audio file corresponding to the first display duration from a preset voice library, the preset voice library includes a correspondence between a display duration and an audio file;

playing, when an animation of the first background picture is displayed, the second audio file.

Optionally, the method further includes:

acquiring a first click frequency at which the user clicks keys on the input method interface;

searching a third audio file corresponding to the first click frequency from a preset voice library, the preset voice library includes a correspondence between a click frequency and an audio file;

playing, when an animation of the first background picture is displayed, the third audio file.

Optionally, after displaying the animation of the first background picture, the method further includes:

acquiring an accumulated duration elapsed after the user stops clicking a key on the input method interface;

stopping, when the accumulated duration exceeds a first threshold, displaying the animation of the first background picture.

Optionally, after displaying an animation of the first background picture according to the displacement of the three-dimensional element, the method further includes:

acquiring text information edited by the user on the input method interface;

displaying, according to a semantic feature of the text information, an animation of the first background picture.

Optionally, the gravity sensing information includes a rotational angular velocity;

After displaying an animation of the first background picture according to the displacement of the three-dimensional element, the method further includes:

determining whether the rotational angular velocity exceeds a second threshold;

selecting, when the rotational angular velocity exceeds the second threshold, a second background picture from a background picture library;

replacing the background picture of the input method interface with the second background picture.

Optionally, the step of selecting a second background picture from a background picture library when the rotational angular velocity exceeds the second threshold includes:

displaying prompt information when the rotational angular velocity exceeds the second threshold, the prompt information is configured for prompting the user to determine whether to replace the background picture of the input method interface;

receiving a confirmation instruction input by the user for the prompt information;

selecting, according to the confirmation instruction, a second background picture from a background picture library.

Optionally, the step of displaying an animation of the first background picture according to the displacement of the three-dimensional element includes:

determining a moving distance of the displacement of the three-dimensional element;

displaying, according to the moving distance, an animation of the first background picture.

A second aspect of the present application provides an animation display apparatus, including:

an acquiring module, configured for acquiring, when it is detected that the user opens an input method interface, a gravity sensing information of the user device;

a determination module, configured for determining, according to the gravity sensing information, the displacement of a three-dimensional element in a first background picture, wherein the first background picture is a background picture of the input method interface;

a display module, configured for displaying, according to the displacement of the three-dimensional element, an animation of the first background picture.

Optionally, the display module is further configured for:

displaying, when it is detected that the user clicks multiple keys on the input method interface, an animation of the first background picture.

Optionally, the determination module is further configured for determining, when it is detected that the user clicks a target key among multiple keys on the input method interface, a display style of the first background picture corresponding to the target key;

the display module is further configured for displaying, according to the display style corresponding to the target key, an animation of the first background picture.

Optionally, the apparatus further includes a searching module, configured for acquiring first identification information of the first background picture, searching a first audio file corresponding to the first identification information from a preset voice library, the preset voice library includes a correspondence between identification information and an audio file;

the display module is further configured for playing, when an animation of the first background picture is displayed, the first audio file.

Optionally, the apparatus further includes a searching module, configured for determining a first display duration of the animation of the first background picture, searching a second audio file corresponding to the first display duration from a preset voice library, the preset voice library includes a correspondence between a display duration and an audio file;

the display module is further configured for playing, when an animation of the first background picture is displayed, the second audio file.

Optionally, the apparatus further includes a searching module, configured for acquiring a first click frequency at which the user clicks keys on the input method interface; searching a third audio file corresponding to the first click frequency from a preset voice library, the preset voice library includes a correspondence between a click frequency and an audio file;

the display module is further configured for playing, when an animation of the first background picture is displayed, the third audio file.

Optionally, the acquiring module is further configured for acquiring an accumulated duration elapsed after the user stops clicking a key on the input method interface;

the display module is further configured for stopping, when the accumulated duration exceeds a first threshold, displaying the animation of the first background picture.

Optionally, the acquiring module is further configured for acquiring text information edited by the user on the input method interface;

the display module is further configured for displaying, according to a semantic feature of the text information, an animation of the first background picture.

Optionally, the gravity sensing information includes a rotational angular velocity;

the determination module is further configured for determining whether the rotational angular velocity exceeds a second threshold, and selecting, when the rotational angular velocity exceeds the second threshold, a second background picture from a background picture library;

the display module is further configured for replacing the background picture of the input method interface with the second background picture.

Optionally, the determination module is further configured for displaying prompt information when the rotational angular velocity exceeds the second threshold, the prompt information is configured for prompting the user to determine whether to replace the background picture of the input method interface; receiving a confirmation instruction input by the user for the prompt information; and selecting, according to the confirmation instruction, a second background picture from a background picture library.

Optionally, the display module is further configured for:

determining a moving distance of the displacement of the three-dimensional element;

displaying, according to the moving distance, an animation of the first background picture.

A third aspect of the embodiment of the present application provides an electronic device, which includes a processor, a memory, communication interfaces, and a bus.

The processor, the memory and the communication interfaces are connected and communicate with each other via the bus;

the memory stores executable program codes;

the processor runs a program corresponding to the executable program codes by reading the executable program codes stored in the memory, to execute any of the animation display method provided by the first aspect described above.

A fourth aspect of the embodiment of the present application provides a computer readable storage medium, the computer-readable storage medium stores multiple instructions, and the instructions are loaded by a processor and execute any of the animation display method provided by the first aspect described above.

A fifth aspect of the embodiment of the present application provides a computer program, which is configured for executing any of the animation display method provided by the first aspect described above.

To implement the technical solution provided by the embodiment of the present application, first, when it is detected that the user opens an input method interface, gravity sensing information of the user device is acquired; and then, the displacement of the three-dimensional element in a first background picture on the input method interface is determined according to the gravity sensing information; and then the animation of the first background picture is displayed according to the displacement of the three-dimensional element. By adding a three-dimensional element in the background picture and controlling the three-dimensional element to move according to the gravity sensing information, the interest and interaction of the input method input may be improved.

### BRIEF DESCRIPTION OF THE DRAWINGS

In order to more clearly describe the technical solution of the embodiments of the application, drawings needed in the embodiments will be briefly described below. Obviously, the drawings described below are for only some embodiments of the present application, one of ordinary skills in the art can also obtain other drawings based on these drawings without any creative efforts.

FIG. 1 is a schematic flowchart depicting an animation display method according to an embodiment of the present application;

FIG. 2 is a schematic diagram depicting a user device deflection according to an embodiment of the present application;

FIG. 3 is a schematic diagram depicting an input method interface according to an embodiment of the present application;

FIG. 4 is a schematic diagram depicting a display style of a background picture according to an embodiment of the present application;

FIG. 5 is a schematic diagram depicting a display style of another background picture according to an embodiment of the present application;

FIG. 6 is a schematic diagram depicting a display style of another background picture according to an embodiment of the present application;

FIG. 7 is a schematic diagram depicting a switching background picture according to an embodiment of the present application;

FIG. 8 is a schematic flowchart depicting another animation display method according to an embodiment of the present application;

FIG. 9 is a schematic diagram of acquiring text information according to an embodiment of the present application;

FIG. 10 is a schematic structural diagram depicting an animation display apparatus according to an embodiment of the present application;

FIG. 11 is a schematic structural diagram depicting an electronic device according to an embodiment of the present application.

### DETAILED DESCRIPTION

The technical solution of the application will be described in detail with reference to the drawings of embodiments of the present application. Obviously, the embodiments described are only some instead of all of the embodiments of the present application. All further embodiments obtained by those of ordinary skills in the art based on the embodiments herein without any creative efforts are within the scope of the present application.

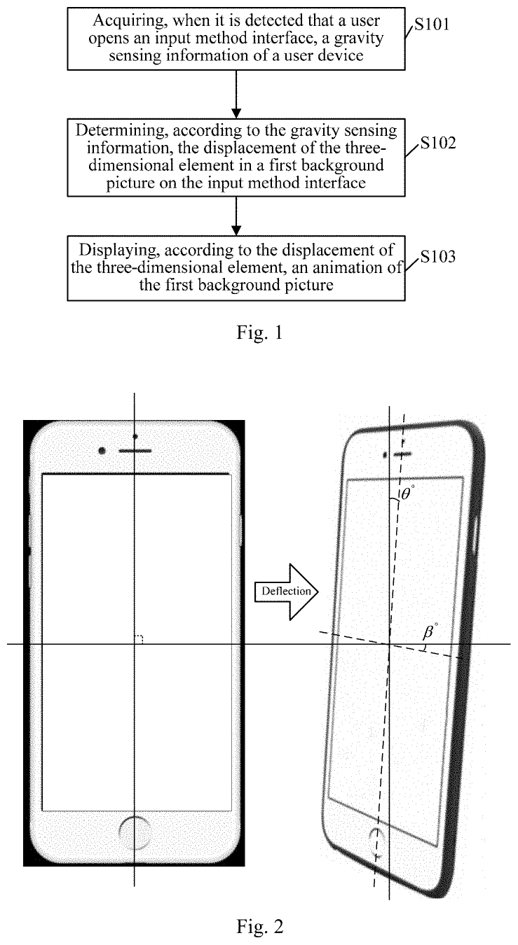

Referring to FIG. 1, FIG. 1 is a schematic flowchart depicting an animation display method according to an embodiment of the present application. As shown in FIG. 1, the animation display method provided by the embodiment of the present application may be applied to user devices such as a mobile terminal and the like. The method includes the following steps.

S101, acquiring, when it is detected that a user opens an input method interface, a gravity sensing information of a user device.

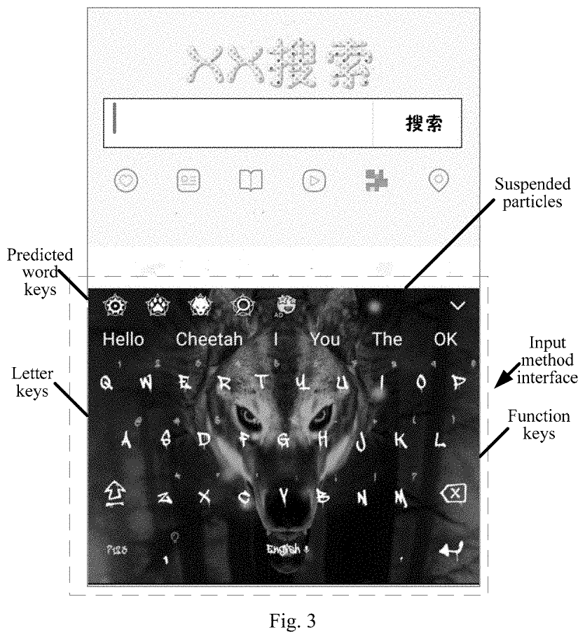

Optionally, when the user needs to input text information in the user interaction interface on the user device, an input method interface may be opened for text editing. For example, as shown in FIG. 3, when the user needs to input search content into a search content input box of a browser, if the user device detects that the user clicks the search content input box of the browser, it is determined that the user needs to input the search content in the search content input box of the browser. And the user device opens the input method interface for text editing, that is, the user device detects that the user opens the input method interface. The gravity sensing information may include, but is not limited to, a rotational angular velocity and a vertical direction of the user device. For example, when it is detected that the input method interface is opened, the user device may use a gyroscope carried in the user device to measure the rotational angular velocity of the user device when deflecting or tilting, and the vertical direction of the user device after deflecting or tilting.

For example, as shown in FIG. 2, if the time of deflection of a mobile phone is t (s), the mobile phone deflects to the left by β°, tilts to the rear by θ°. Wherein, in order to convert β° and θ° from angle to radian, (β°/360°) and (θ°/360°) are calculated, and then the rotational angular velocity of (β°/360°)/t rad/s and (θ°/360°)/t rad/s may be obtained. At the same time, due to a backward movement of a center of gravity, the vertical direction of the mobile phone changes from being perpendicular to a horizontal axis to being backward tilted by θ° and left deflected by β°.

In the embodiment of the present application, if the user device is perpendicular to the ground, and there is only a deflection to the left or right, and no backward or forward tilt, it is determined that the vertical direction of the user device is unchanged.

S102, determining, according to the gravity sensing information, the displacement of the three-dimensional element in a first background picture on the input method interface.

That is, determining, according to the gravity sensing information, a displacement of a three-dimensional element in a first background picture, wherein the first background picture is a background picture of the input method interface.

In the embodiment of the present application, the first background picture is any one background picture. Here, the first background picture is used as an example for description, and is not limiting. The background picture of the input method interface is a three-dimensional stereoscopic picture. Wherein each point in the three-dimensional stereoscopic picture is a point in a three-dimensional space, and each point may be regarded as a three-dimensional element of the three-dimensional stereoscopic picture. The content of a three-dimensional stereoscopic picture (such as a flower or a wolf) is composed of three-dimensional elements, and it is stereoscopic on a visual effect and can achieve a three-dimensional dynamic effect. For example, the “wolf” in the three-dimensional stereoscopic picture is different from a two-dimensional planar image. It can not only realize actions of shaking head and swinging tail, but also the “wolf” seen by the user is stereoscopic.

In the embodiment of the present application, the displacement of the three-dimensional elements may include, but is not limited to, a moving direction and a moving speed of the three-dimensional elements.

Optionally, when the vertical direction of the user device changes, the moving direction of a three-dimensional element may be determined according to the vertical direction of the user device measured in real time, and the moving speed of the three-dimensional element may be determined according to the rotational angular velocity of the user device. For example, when the vertical direction of the user device changes and when the user device deflects to the left, the user device determines that the moving direction of the three-dimensional element of the background picture of the input method interface is to move to the left, and the moving speed is the same as the rotational angular velocity of the user device.

S103, displaying, according to the displacement of the three-dimensional element, an animation of the first background picture.

Optionally, when the user device deflects or tilts, the user device may determine a moving distance of the displacement of the three-dimensional element according to the determined moving direction and speed of the displacement of the three-dimensional element, and control the moving of the first background picture according to the determined moving distance. The movement process of the three-dimensional element in the first background picture forms a three-dimensional animation effect. That is, the user device displays an animation of the first background picture according to the determined moving distance. The moving distance includes a moving direction and a deflection angle.

For example, if the time of deflection of a mobile phone is t (s), the mobile phone deflects to the left by β°. The mobile phone determines that the moving direction of the displacement of the three-dimensional element is to the left, and the moving speed of the displacement of the three-dimensional element is (β°/360°)/t, then the three-dimensional element is controlled to deflect to the left by β° with the rotation angular velocity of (β°/360°)/t.

In this present embodiment, the movement of the three-dimensional element in the first background picture is controlled according to the moving direction and speed of the displacement of the three-dimensional element, thereby realizing the deflection or tilt of the user device, synchronization with the movement of the three-dimensional element, and improving the interest.

Optionally, the user device may obtain first identification information of the first background picture, and the first identification information includes, but is not limited to, a name of the first background picture. Then the user device searches a first audio file corresponding to the first identification information from a preset voice library, the preset voice library may include a correspondence between identification information and an audio file. Wherein the preset voice library includes at least one audio file, and a correspondence between the audio file and identification information of at least one background picture. The user device may play the first audio file when an animation of the first background picture is displayed. For example, as shown in Table 1, the preset voice library includes three audio files: apple.mp3, pear.wav, and abc.mp3, where apple.mp3 corresponds to the background picture X1, pear.wav corresponds to the background picture X2, and abc .mp3 corresponds to the background picture X3. When an animation of the background picture X1 is displayed, the audio file apple.mp3 is played; when displaying the animation of the background picture X2, the audio file pear.wav is played; and when the animation of the background picture X3 is displayed, the audio file abc.mp3 is played.

TABLE 1
Preset voice library

| Name of a background picture | Audio file |
|---|---|
| X1 | apple.mp3 |
| X2 | pear.wav |
| X3 | abc.mp3 |

Optionally, the user device may determine a first display duration of the animation of the first background picture, where the first display duration is a length of time required to completely display the animation of the first background picture. Then the user device searches a second audio file corresponding to the first display duration from a preset voice library, the preset voice library may include a correspondence between display duration and an audio file. The user device may play the second audio file when an animation of the first background picture is displayed. For example, as shown in Table 2, the preset voice library includes three audio files: apple.mp3, pear.wav, and abc.mp3, where the display duration corresponding to apple.mp3 is 3 seconds and the display duration corresponding to pear.wav is 5 seconds, and the display duration corresponding to abc.mp3 is 4 seconds. When the display duration of the animation of the background picture is 3 seconds, the audio file apple.mp3 is played; when the display duration of the animation of the background picture is 5 seconds, the audio file pear.wav is played; and when the display duration of the animation of the background picture is 4 seconds, the audio file abc.mp3 is played.

TABLE 2
Preset voice library

| Display time | Audio file |
|---|---|
| 3 seconds | apple.mp3 |
| 5 seconds | pear.wav |
| 4 seconds | abc.mp3 |

Optionally, the input method interface includes multiple keys. The user device may obtain a first click frequency at which the user clicks keys on the input method interface. In one example, the user device may obtain the first click frequency of the keys by counting the number of times that the user clicks the keys over a period of time, and dividing the number of times by time. The user device searches a third audio file corresponding to the first click frequency from a preset voice library, the preset voice library may include a correspondence between a click frequency and an audio file. The user device may play the third audio file when an animation of the first background picture is displayed. For example, as shown in Table 3, the preset voice library includes three audio files: apple.mp3, pear.wav, and abc.mp3, where the click frequency corresponding to apple.mp3 is 2 per second, the click frequency corresponding to pear.wav is 3 per second, and the click frequency corresponding to abc.mp3 is 4 per second. When the click frequency is 2 per second, the audio file apple.mp3 is played; when the click frequency is 3 per second, the audio file pear.wav is played; and the click frequency is 4 per second, the audio file abc.mp3 is played.

TABLE 3
Preset voice library

| Click frequency | Audio file |
|---|---|
| 2 per second | apple.mp3 |
| 3 per second | pear.wav |
| 4 per second | abc.mp3 |

In the embodiment of the present application, the period of time during which counting the number of times that the user clicks the keys can be set according to actual needs. For example, the period of time may be 10 seconds.

Optionally, the user device may obtain at least two of the first identification information of the first background picture, the first display duration of the animation, and the first click frequency at which the user clicks the keys on the input method interface; then search a fourth audio file corresponding to at least two of the first identification information of the first background picture, the first display duration of the animation, and the first click frequency at which the user clicks the keys on the input method interface from the preset voice library. The preset voice library may include the correspondence between at least two items of identification information, display duration, and click frequency with the audio file. The user device may play the fourth audio file when an animation of the first background picture is displayed. For example, as shown in Table 4, the preset voice library includes a correspondence between the name of the background, the click frequency and the audio file. According to Table 4, when the animation of the background picture X1 is displayed, if the user clicks the keys on the input method interface with a click frequency of 2 per second, the audio file apple1.mp3 is played.

TABLE 4
Preset voice library

| Name of a background picture | Key click frequency | Audio file |
|---|---|---|
| X1 | 2 per second | apple1.mp3 |
| | 3 per second | apple2.mp3 |
| X2 | 2 per second | pear1.wav |
| | 3 per second | pear2.wav |
| X3 | 2 per second | abc1.mp3 |
| | 3 per second | abc2.mp3 |

Optionally, the user device may search a corresponding audio file from the preset voice library according to the displayed content of the animation of the first background picture. The user device plays the searched audio file when an animation of the first background picture is displayed. For example, if the content of the animation of the first background picture is fireworks, the user device may search a sound effect of fireworks from a preset voice library. When the animation of fireworks is played, the user device plays the sound effect of fireworks.

Optionally, as shown in FIG. 3, there are multiple keys in the input method interface, the multiple keys include multiple letter keys, multiple function keys, and multiple predicted word keys. Wherein the letter keys may be used for word spelling, the function keys may be used to switch between Chinese/English input or word/character input, and the predicted word keys may be used to display the predicted words obtained according to an order in which the user successively clicks the letter keys. The user device displays an animation of the first background picture when it is detected that the user clicks multiple keys on the input method interface. Wherein the animation in the displayed first background picture is irrelevant to the keys clicked by the user. In one embodiment, the user device may randomly display the animation in the first background picture. In another embodiment, the user device may further display an animation of the first background picture according to a preset animation display order.

For example, the background picture of the input method interface is “a wolf”. The animation of “a wolf” includes: Animation 1 of “wolf eyes” being lit, and Animation 2 of “wolf” shaking his head. When it is detected that the user clicks one key on the input method interface, no matter which key on the input method interface the user clicks, the user device randomly selects one animation from Animation 1 and Animation 2, for example, if the user selects Animation 1, Animation 1 of “wolf eyes” being lit in the background picture is displayed. When it is detected that the user clicks one key on the input method interface again, no matter which key on the input method interface the user clicks, the user device randomly selects an animation from Animation 1 and Animation 2, for example, if the user selects Animation 2, Animation 2 of “wolf” shaking his head in the background picture is displayed.

For example, the background picture of the input method interface is “a wolf”. The animation of “a wolf” includes: Animation 1 of “wolf eyes” being lit, and Animation 2 of “wolf” shaking his head. The preset animation display order is Animation 1→Animation 2. When it is detected that the user clicks one key on the input method interface, no matter which key on the input method interface the user clicks, the user device displays Animation 1 of “wolf eyes” being lit in the background picture. When it is detected that the user clicks one key on the input method interface again, no matter which key on the input method interface the user clicks, the user device displays Animation 2 of “wolf” shaking his head in the background picture.

Optionally, when it is detected that the user clicks a target key among multiple keys on the input method interface, the user device may determine a display style of the first background picture corresponding to the target key; and display an animation of the first background picture according to the display style corresponding to the target key.

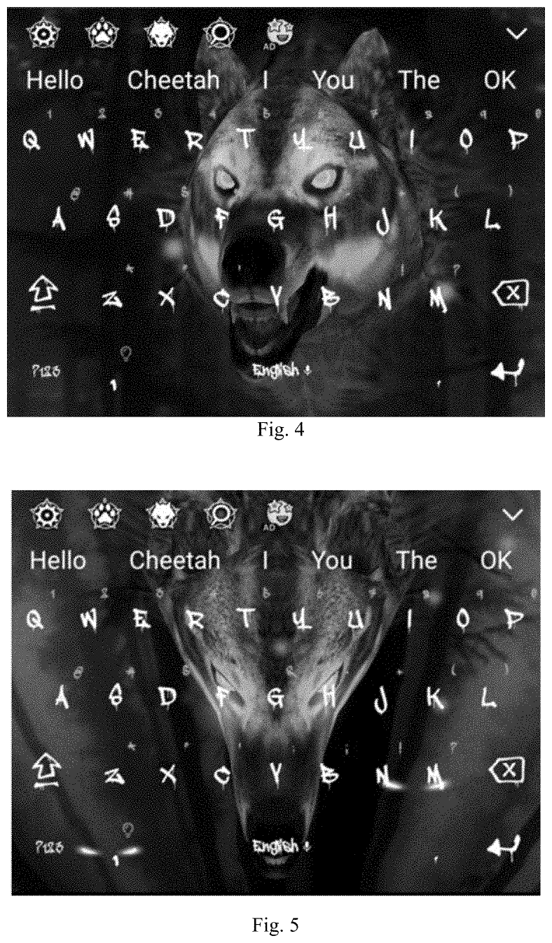

For example, as shown in FIG. 4, when the mobile phone deflects to the left and rear, the background picture will shift to the left rear. Specifically, the gyroscope moves to the left rear to find a new balance point of gravity, the “wolf” in the background picture turns his head to the left. The display style of the background picture corresponding to the function key set in the mobile phone is: display the animation of “wolf eyes” being lit, and play the sound of wolf howling; the display style of the background picture corresponding to the letter key “A” is: display the animation of “wolf” turning his head to the right and returning to the front, and bowing his head at the same time. In the process of the mobile phone deflecting, when it is detected that the user clicks a function key, according to the display style of the background picture corresponding to the function key, an animation in which “wolf eyes” in the background picture being lit is displayed, and the sound of wolf howling searched from the preset voice library is played simultaneously. When it is detected that the user clicks the letter key “A”, according to the display style of the background picture corresponding to the letter key “A”, the animation of “wolf” turning his head to the right and returning to the front, and bowing his head at the same time is displayed. In the whole process of the above deflection from the phone to the left and rear, the user clicks the function key, and the user clicks the letter key “A”, the display style of the background picture changes into a set of coherent three-dimensional animations, and a picture shown in FIG. 5 may be obtained finally.

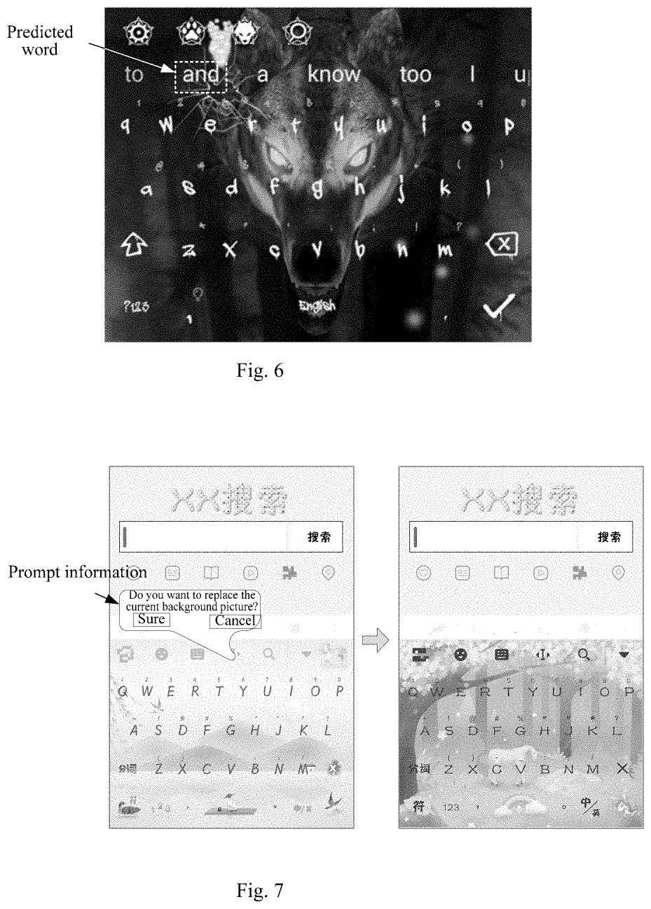

And for example: as shown in FIG. 6, the predicted words displayed on the seven predicted word keys in the input method interface are “to”, “and”, “a”, “know”, “too”, “I”, and “u”. The display style of the background picture corresponding to the predicted word key “and” set in the mobile phone is: an animation showing a broken screen and a flame burning; the display style of the background picture corresponding to the predicted word key “know” is: an animation showing fireworks. When it is detected that the user clicks the predicted word key “and”, the animation showing a broken screen and a flame burning of the background picture is displayed according to the display style of the background picture corresponding to the predicted word key “and”. When it is detected that the user clicks the predicted word key “know”, the animation showing fireworks of the background picture is displayed according to the display style of the background picture corresponding to the predicted word key “know”.

Optionally, in order to save running resources of the user device, the user device may obtain the accumulated duration elapsed after the user stops clicking the multiple keys after detecting that the user clicks keys on the input method interface; when the accumulated duration exceeds a first threshold, the animation of the first background picture is stopped. That is, when the accumulated duration exceeds a first threshold, the first background picture stops changing. Wherein the first threshold includes, but is not limited to, 10 s. For example, the first threshold is 10 s. When it is detected that the user clicks on a function key, the timing is started. If it is not detected that the user clicks any keys during the accumulated duration from the start of the timing to the timing which exceeds 10 s, the animation of the first background picture is stopped.

Optionally, in order to provide the user with the function of switching the background picture of the input method interface by rotating the user device, the user device may determine whether the rotational angular velocity exceeds a second threshold, and the second threshold includes, but is not limited to, 90 rad/s. When the rotational angular velocity exceeds the second threshold, a second background picture is selected from a background picture library. Wherein the background picture library includes at least one background picture, and each background picture is a three-dimensional stereoscopic picture. The manner of selecting the second background picture from the background picture library includes: selecting the most recently used background picture as the second background picture, or selecting the most frequently used background picture other than the first background picture as the second background picture, or selecting a background picture with the highest similarity of the first background picture as the second background picture and so on. The user device replaces the background picture of the input method interface with the second background picture. Wherein the first background picture and the second background picture are background pictures with different picture contents and/or picture styles.

Optionally, in order to provide the user with the function of switching the background picture of the input method interface by rotating the user device. Specifically, when the rotational angular velocity exceeds the second threshold, the user device may display prompt information, the prompt information is used to prompt whether the user confirms changing the background picture of the input method interface. The user inputs a confirmation instruction or a cancel instruction to the user device according to the prompt information. The confirmation instruction is used for instructing the user device to select a second background picture from a background picture library, and the cancel instruction is used for instructing the user device not to select the second background picture from the background picture library. The user device receives a confirmation instruction input by the user for the prompt information, and selects, according to the confirmation instruction, a second background picture from a background picture library, and replaces the background picture of the input method interface with the second background picture. The first background picture and the second background picture are background pictures with different picture contents and/or picture styles. The user device receives a cancel instruction input by the user for the prompt information, and does not select, according to the cancel instruction, a second background picture from a background picture library, and does not replace the background picture of the input method interface with the second background picture.

For example: a second threshold is 90 rad/s. The manner of selecting a second background picture from a background picture library includes: selecting the most frequently used background picture other than the first background picture as the second background picture. As shown in FIG. 7, the background picture of the current input method interface is the background picture 1 of the input method interface on the left in FIG. 7. When the rotational angular velocity exceeds 90 rad/s, the prompt information “Do you want to replace the current background picture?” may be displayed at the top of the input method interface, which is the prompt information in the input method interface on the left in FIG. 7. When it is detected that the user clicks a key “sure”, the most frequently used background picture other than the current background picture is selected from the background picture library. For example, if the background picture 2 of the input method interface on the right in FIG. 7 is selected, the user device may replace the background picture of the input method interface with the background picture 2.

In the embodiment of the present application, when it is detected that the user opens an input method interface, gravity sensing information of the user device is acquired; and then, the displacement of the three-dimensional element in a first background picture on the input method interface is determined according to the gravity sensing information; and then the animation of the first background picture is displayed according to the displacement of the three-dimensional element. By adding three-dimensional elements to the background picture, controlling the three-dimensional elements to move according to the gravity sensing information, and displaying different three-dimensional motion effects on the background picture when the user clicks different keys, the interest and interaction of input information in the input method input may be improved.

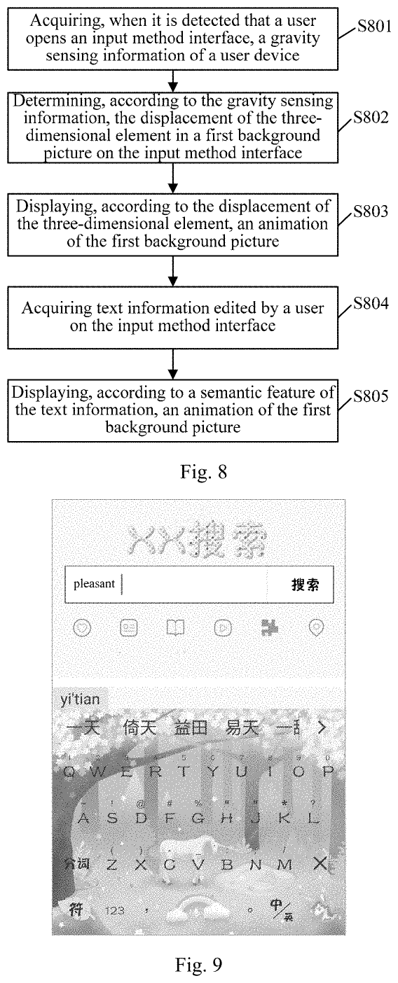

Referring to FIG. 8, FIG. 8 is a schematic flowchart depicting another animation display method according to an embodiment of the present application. As shown in FIG. 8, the method in the embodiment of the present application may include the following steps.

S801, acquiring, when it is detected that the user opens an input method interface, a gravity sensing information of the user device. This step is the same as S101 of the previous embodiment, and this step is not repeated here.

S802, determining, according to the gravity sensing information, the displacement of the three-dimensional element in a first background picture on the input method interface. This step is the same as S102 of the previous embodiment, and this step is not repeated here.

S803, displaying, according to the displacement of the three-dimensional element, an animation of the first background picture. This step is the same as S103 of the previous embodiment, and this step is not repeated here.

S804, acquiring text information edited by the user on the input method interface.

Optionally, the user may click the letter keys of the input method to spell out text information to be input to the user device, and input the text information into a text input box of the user interaction interface. Wherein the text input box includes, but is not limited to, a message input box of a QQ chat interface, a search content input box of a browser interface, and the like. The user device obtains text information input by the user into the text input box. For example, as shown in FIG. 9, the user opens an input method interface to edit the text information “pleasant” and inputs “pleasant” into the search content input box of the browser. The user device can obtain the text information “pleasant” that the user inputs in the search content input box.

S805, displaying, according to a semantic feature of the text information, an animation of the first background picture.

Optionally, semantic features of the text information may include emotions and specific names expressed by the text information, and the like. Specifically, the user device may identify the semantic features of the text information by utilizing semantic recognition technology, thereby identifying emotions expressed by the text information, such as happiness, sadness, etc., or identifying specific names that the text message refers to, such as character names, festival names, etc. The user device displays the animation of the first background picture according to the expressed emotion or the specified name of the text information. For example, if the first background picture includes a human face, when the obtained text information is “pleasant”, the user device may determine that the text information expresses a happy mood, and display the animation of the face for smile in the first background picture. For another example, when the acquired text information is “Mid-Autumn Festival”, an animation of scattering moon cakes in the first background picture may be displayed.

In the embodiment of the present application, when it is detected that the user opens an input method interface, gravity sensing information of the user device is acquired; and then, the displacement of the three-dimensional element in a first background picture on the input method interface is determined according to the gravity sensing information; and then the animation of the first background picture is displayed according to the displacement of the three-dimensional element. By adding three-dimensional elements to the background picture, controlling the three-dimensional elements to move according to the gravity sensing information, and displaying different three-dimensional motion effects on the background picture when the user clicks different keys, the interest and interaction of input information in the input method input may be improved.

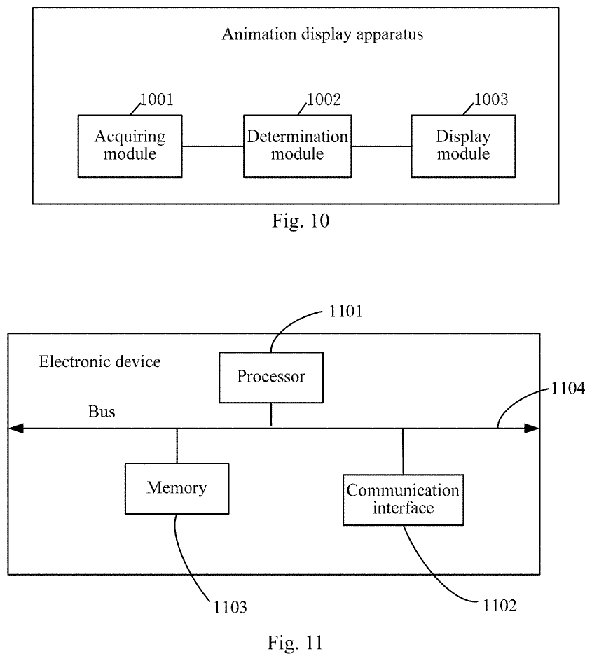

Corresponding to the embodiment of the animation display method described above, the embodiment of the present application also provides an animation display apparatus. Referring to FIG. 10, FIG. 10 is a schematic structural view depicting an animation display apparatus according to an embodiment of the present application. As shown in the figure, the embodiment of the present application includes:

an acquiring module 1001, configured for acquiring, when it is detected that the user opens an input method interface, a gravity sensing information of the user device.

Optionally, when the user needs to input text information in the user interaction interface on the user device, an input method interface may be opened for text editing. For example, as shown in FIG. 3, when the user needs to input search content into a search content input box of a browser, if the user device detects that the user clicks the search content input box of the browser, it is determined that the user needs to input the search content in the search content input box of the browser. And the user device opens the input method interface for text editing, that is, the user device detects that the user opens the input method interface. The gravity sensing information may include, but is not limited to, a rotational angular velocity and a vertical direction of the user device. For example, when it is detected that the input method interface is opened, the acquiring module 1001 may use a gyroscope carried in the user device to measure the rotational angular velocity of the user device when deflecting or tilting, and the vertical direction of the user device after deflecting or tilting.

A determination module 1002 is configured for determining, according to the gravity sensing information, the displacement of the three-dimensional element in a first background picture on the input method interface. That is, the determination module 1002 may be configured for determining, according to the gravity sensing information, a displacement of a three-dimensional element in a first background picture, wherein the first background picture is a background picture of the input method interface.

In the embodiment of the present application, the first background picture is any one background picture. Here, the first background picture is used as an example for description, and is not limiting. The background picture of the input method interface is a three-dimensional stereoscopic picture. Wherein each point in the three-dimensional stereoscopic picture is a point in a three-dimensional space, and each point may be regarded as a three-dimensional element of the three-dimensional stereoscopic picture. The content of a three-dimensional stereoscopic picture (such as a flower or a wolf) is composed of three-dimensional elements, and it is stereoscopic on a visual effect and can achieve a three-dimensional dynamic effect. For example, the “wolf” in the three-dimensional stereoscopic picture is different from a two-dimensional planar image. It can not only realize actions of shaking head and swinging tail, but also the “wolf” seen by the user is stereoscopic.

In the embodiment of the present application, the displacement of the three-dimensional elements may include, but is not limited to, a moving direction and a moving speed of the three-dimensional elements.

Optionally, the determination module 1002 may determine the moving direction of a three-dimensional element according to the vertical direction of the user device measured in real time when the vertical direction changes, and may determine the moving speed of the three-dimensional element according to the rotational angular velocity of the user device. For example, when the vertical direction of the user device changes and when the user device deflects to the left, the determination module 1002 determines that the moving direction of the three-dimensional element of the background picture of the input method interface is to move to the left, and the moving speed is the same as the rotational angular velocity of the user device.

A display module 1003 is configured for displaying, according to the displacement of the three-dimensional element, an animation of the first background picture.

Optionally, when the user device deflects or tilts, the display module 1003 may determine a moving distance of the displacement of the three-dimensional element according to the determined moving direction and speed of the displacement of the three-dimensional element, and control the moving of three-dimensional element in the first background picture according to the determined moving distance. The movement process of the three-dimensional element in the first background picture forms a three-dimensional animation effect. That is, the display module 1003 displays an animation of the first background picture according to the determined moving distance. The moving distance includes a moving direction and a deflection angle.

In this present embodiment, the movement of the three-dimensional element in the first background picture is controlled according to the moving direction and speed of the displacement of the three-dimensional element, thereby realizing the deflection or tilt of the user device, synchronization with the movement of the three-dimensional element, and improving the interest.

Optionally, the apparatus of the embodiment of the present application may further include a searching module, configured for acquiring first identification information of the first background picture. The user device searches a first audio file corresponding to the first identification information from a preset voice library, the preset voice library may include a correspondence between identification information and an audio file. The display module 1003 may be further configured for playing, when an animation of the first background picture is displayed, the first audio file.

Optionally, the searching module may be further configured for determining a first display duration of the animation of the first background picture, where the first display duration is a length of time required to completely display the animation of the first background picture. Then the searching module searches a second audio file corresponding to the first display duration from a preset voice library, the preset voice library may include a correspondence between display duration and an audio file, wherein the preset voice library includes at least one audio file and a correspondence between the audio file and at least one display duration. The display module 1003 may be further configured for playing, when an animation of the first background picture is displayed, the searched second audio file.

Optionally, the input method interface includes multiple keys. The searching module may be further configured for obtaining a first click frequency at which the user clicks keys on the input method interface. In one example, the searching module may obtain the first click frequency of the keys by counting the number of times that the user clicks the keys over a period of time, and dividing the number of times by time. The searching module searches a third audio file corresponding to the first click frequency from a preset voice library, the preset voice library may include a correspondence between a click frequency and an audio file. The display module 1003 may be further configured for playing, when an animation of the first background picture is displayed, the third audio file.

In the embodiment of the present application, the period of time during which counting the number of times that the user clicks the keys can be set according to actual needs.

Optionally, the searching module may be further configured for obtaining at least two of the first identification information of the first background picture, the first display duration of the animation, and the first click frequency at which the user clicks the keys on the input method interface; then searching a fourth audio file corresponding to at least two of the first identification information of the first background picture, the first display duration of the animation, and the first click frequency at which the user clicks the keys on the input method interface from the preset voice library. The preset voice library may include the correspondence between at least two items of identification information, display duration, and click frequency with the audio file. The display module 1003 may be further configured for playing, when an animation of the first background picture is displayed, the fourth audio file.

Optionally, the display module 1003 may be further configured for displaying an animation of the first background picture when it is detected that the user clicks multiple keys on the input method interface. Wherein the animation in the displayed first background picture is irrelevant to the keys clicked by the user. In one embodiment, the display module 1003 may randomly display the animation in the first background picture. In another embodiment, the display module 1003 may further display an animation of the first background picture according to a preset animation display order.

Optionally, the determination module 1002 may be further configured for determining, when it is detected that the user clicks a target key among multiple keys on the input method interface, a display style of the first background picture corresponding to the target key. The display module 1003 may be further configured for displaying, according to the display style corresponding to the target key, an animation of the first background picture. Specifically, as shown in FIG. 3, there are multiple keys in the input method interface, the multiple keys include multiple letter keys, multiple function keys, and multiple predicted word keys. Wherein the letter keys may be used for word spelling, the function keys may be used to switch between Chinese/English input or word/character input, and the predicted word keys may be used to display the predicted words according to an order in which the user successively clicks the letter keys.

Optionally, in order to save running resources of the user device, the acquiring module 1001 may be further configured for obtaining the accumulated duration elapsed after the user stops clicking the keys on the input method interface after detecting that the user clicks keys on the input method interface. The display module 1003 may be further configured for stopping, when the accumulated duration exceeds a first threshold, displaying the animation of the first background picture. That is, when the accumulated duration exceeds a first threshold, the first background picture stops changing. Wherein the first threshold includes, but is not limited to, 10 s. For example, the first threshold is 10 s. When it is detected that the user clicks on a function key, the timing is started. If it is not detected that the user clicks any keys during the accumulated duration from the start of the timing to the timing which exceeds 10 s, all animations displayed in the first background picture are stopped.

Optionally, in order to provide the user with the function of switching the background picture of the input method interface by rotating the user device, the determination module 1002 may be further configured for determining whether the rotational angular velocity exceeds a second threshold, and the second threshold includes, but is not limited to, 90 rad/s. The determination module 1002 may be further configured for selecting, when the rotational angular velocity exceeds the second threshold, a second background picture from a background picture library. Wherein the background picture library includes at least one background picture, and each background picture is a three-dimensional stereoscopic picture. The manner of selecting the second background picture from the background picture library includes, but is not limited to: selecting the most recently used background picture as the second background picture, or selecting the most frequently used background picture other than the first background picture as the second background picture, or selecting a background picture with the highest similarity of the first background picture as the second background picture and so on. The display module 1003 may be further configured for replacing the background picture of the input method interface with the second background picture. Wherein the first background picture and the second background picture are background pictures with different picture contents and/or picture styles.

Optionally, in order to provide the user with the function of switching the background picture of the input method interface by rotating the user device. The determination module 1002 may be further configured for displaying, when the rotational angular velocity exceeds the second threshold, prompt information, the prompt information is used to prompt whether the user confirms changing the background picture of the input method interface. The user inputs a confirmation instruction or a cancel instruction to the user device according to the prompt information. The confirmation instruction is used for instructing the user device to select a second background picture from a background picture library, and the cancel instruction is used for instructing the user device not to select the second background picture from the background picture library. The determination module 1002 may be further configured for receiving a confirmation instruction input by the user for the prompt information, and selecting a second background picture from a background picture library according to the confirmation instruction. The determination module 1002 may be further configured for receiving a cancel instruction input by the user for the prompt information, and does not select, according to the cancel instruction, a second background picture from a background picture library, and does not replace the background picture of the input method interface with the second background picture.

Optionally, the acquiring module 1001 may be further configured for acquiring text information edited by the user on the input method interface. The display module 1003 may be further configured for displaying, according to a semantic feature of the text information, an animation of the first background picture. Wherein, the display module 1003 may identify the semantic features of the text information by utilizing semantic recognition technology, thereby identifying emotions expressed by the text information or identifying specific names that the text message refers to. The display module 1003 may display the animation of the first background picture according to the expressed emotion or the specified name of the text information. For example, if the first background picture includes a human face, when the obtained text information is “pleasant”, the display module 1003 may determine that the text information expresses a happy mood, and display the animation of the face for smile in the first background picture. For another example, when the acquired text information is “Mid-Autumn Festival”, an animation of scattering moon cakes in the background picture may be displayed.

In the embodiment of the present application, when it is detected that the user opens an input method interface, gravity sensing information of the user device is acquired; and then, the displacement of the three-dimensional element in a first background picture on the input method interface is determined according to the gravity sensing information; and then the animation of the first background picture is displayed according to the displacement of the three-dimensional element. By adding three-dimensional elements to the background picture, controlling the three-dimensional elements to move according to the gravity sensing information, and displaying different three-dimensional motion effects on the background picture when the user clicks different keys, the interest and interaction of input information in the input method input may be improved.

Corresponding to the embodiment of the animation display method described above, the embodiment of the present application also provides an electronic device. Referring to FIG. 11, FIG. 11 is a schematic structural view depicting an electronic device according to an embodiment of the present application. As shown in FIG. 11, the electronic device may include at least one processor 1101, such as a central processing unit (CPU), at least one communication interface 1102, at least one memory 1103, and at least one bus 1104. Wherein the bus 1104 is used to implement connection and communication between these components. In the embodiment of the present application, the communication interface 1102 of the electronic device may be a wired sending port or a wireless sending port, that is, a port which may be a wireless device, including, for example, an antenna device for signaling or data communication with other node devices. The memory 1103 may be a high-speed random access memory (RAM), or an non-volatile memory (NVM), such as at least one disk storage. Optionally, the memory 1103 may also be at least one storage device located away from the processor 1101 described above. A set of executable program codes is stored in the memory 1103, and the processor 1101 is configured for calling the executable program code stored in the memory to run a program corresponding to the executable program codes for performing the following operations:

acquiring, when it is detected that the user opens an input method interface, a gravity sensing information of the user device;

determining, according to the gravity sensing information, the displacement of a three-dimensional element in a first background picture, wherein the first background picture is a background picture of the input method interface;

displaying, according to the displacement of the three-dimensional element, an animation of the first background picture.

Wherein the processor 1101 may be further configured for performing the following operation steps:

displaying, when it is detected that the user clicks keys on the input method interface, an animation of the first background picture.

Wherein the processor 1101 may be further configured for performing the following operation steps:

determining, when it is detected that the user clicks a target key among multiple keys on the input method interface, a display style of the first background picture corresponding to the target key;

displaying, according to the display style corresponding to the target key, an animation of the first background picture.

Wherein the processor 1101 may be further configured for performing the following operation steps:

acquiring first identification information of the first background picture;

searching a first audio file corresponding to the first identification information from a preset voice library, the preset voice library includes a correspondence between identification information and an audio file;

playing, when an animation of the first background picture is displayed, the first audio file.

Wherein the processor 1101 may be further configured for performing the following operation steps:

determining a first display duration of the animation of the first background picture;

searching a second audio file corresponding to the first identification information from a preset voice library, the preset voice library includes a correspondence between identification information and an audio file;

playing, when an animation of the first background picture is displayed, the second audio file.

Wherein the processor 1101 may be further configured for performing the following operation steps:

acquiring a first click frequency at which the user clicks keys on the input method interface;

searching a third audio file corresponding to the first click frequency from a preset voice library, the preset voice library includes a correspondence between a click frequency and an audio file;

playing, when an animation of the first background picture is displayed, the third audio file.

Wherein the processor 1101 may be further configured for performing the following operation steps:

acquiring an accumulated duration elapsed after the user stops clicking a key on the input method interface;

stopping, when the accumulated duration exceeds a first threshold, displaying the animation of the first background picture.

Wherein the processor 1101 may be further configured for performing the following operation steps:

acquiring text information edited by the user on the input method interface;

displaying, according to a semantic feature of the text information, an animation of the first background picture.

Wherein, the gravity sensing information includes a rotational angular velocity;

the processor 1101 may be further configured for performing the following operation steps:

determining whether the rotational angular velocity exceeds a second threshold;

selecting, when the rotational angular velocity exceeds the second threshold, a second background picture from a background picture library;

replacing the background picture of the input method interface with the second background picture.

Wherein the processor 1101 may be further configured for performing the following operation steps:

displaying prompt information when the rotational angular velocity exceeds the second threshold, the prompt information is configured for prompting the user to determine whether to replace the background picture of the input method interface;

receiving a confirmation instruction input by the user for the prompt information;

selecting, according to the confirmation instruction, a second background picture from a background picture library.

Wherein the processor 1101 may be further configured for performing the following operation steps:

determining a moving distance of the displacement of the three-dimensional element;

displaying, according to the moving distance, an animation of the first background picture.

Corresponding to the embodiment of the animation display method described above, an embodiment of the present application further provides a computer readable storage medium, where the computer readable storage medium is configured for storing an application program, and any of the operations in the animation display method shown in FIG. 1-9 is performed by the electronic device when the application program is being executed.

Corresponding to the embodiment of the animation display method described above, an embodiment of the present application further provides a computer readable storage medium, where the computer readable storage medium is configured for storing multiple instructions, and any of the operations in the animation display method shown in FIG. 1-9 is performed by the electronic device when the instructions are loaded and executed by the processor.

Corresponding to the embodiment of the animation display method described above, an embodiment of the present application further provides a computer program, any of the operations in the animation display method shown in FIG. 1-9 performed by the electronic device when the computer program is being executed

It should be noted that, for the purpose of simple description, the above-mentioned method embodiments are all described as a series of action combinations, but those skilled in the art should know that the present application is not limited by the described action order. Because according to the present application, some steps may be performed in other orders or at the same time. Secondly, those skilled in the art should also know that the embodiments described in the specification are all preferred embodiments, and the actions and modules involved are not necessarily required for this application.

For the description of each of the embodiments of the present application, the emphasis is laid on a particular aspect. For the parts that are not described in detail in a certain embodiment, references can be made to the related description in other embodiments.

Those skilled in the art may understand that all or part of the steps in the various methods of the foregoing embodiments may be implemented by instructing a related hardware through a program. The program may be stored in a computer readable storage medium. The storage medium may include: a flash disk, a read-only memory (ROM), a random access device (RAM), a magnetic disk or an optical disk, etc.

The content download method and related devices and systems provided in the embodiments of the present application have been described in detail above. Specific examples have been used in this document to describe the principle and implementation of the present application. The descriptions of the above embodiments are only used to help understand the method of the present application and its core ideas. At the same time, for those of ordinary skill in the art, according to the ideas of this application, there will be changes in the specific implementation and application scope. In summary, the contents of this specification should not be understood as a limitation on this application.

In the description of this specification, the description with reference to the terms “one embodiment”, “some embodiments”, “examples”, “specific examples”, or “some examples” and the like means that specific features, structures, materials or features described in conjunction with the embodiments or examples are included in at least one embodiment or example of the present application. In this specification, the schematic expressions of the above terms are not necessarily directed to the same embodiment or example. Moreover, the specific features, structures, materials, or features described may be combined in any suitable manner in any one or more embodiments or examples. In addition, without any contradiction, those skilled in the art may combine different embodiments or examples and features of the different embodiments or examples described in this specification.

In addition, the terms “first” and “second” are used for descriptive purposes only, and cannot be understood as indicating or implying relative importance or implying the number of indicated technical features. Therefore, the features defined as “first” and “second” may explicitly or implicitly include at least one of the features. In the description of the present application, the meaning of “multiple” is at least two, for example, two, three, etc., unless it is specifically defined otherwise.

Any process or method description in a flowchart or otherwise described herein may be understood as a module, fragment, or portion of code that includes one or more executable instructions for implementing a particular logical function or step of a process. And the scope of the preferred embodiments of this application includes additional implementations in which the functions may be performed out of the order shown or discussed, including performing the functions in a substantially simultaneous manner or in the reverse order according to the functions involved, which should be understood by those skilled in the technical field of the embodiment of the present application.

For example, logic and/or steps represented in a flowchart or otherwise described herein may be considered as a ordered list of executable instructions for implementing logical functions, and may be specifically implemented in any computer readable medium for an instruction execution system, apparatus or device (such as a computer-based system, a system including a processor, or other system that may cancel and execute instructions from an instruction execution system, apparatus, or device) or for use in combination with an instruction execution system, apparatus, or device. For the purposes of this specification, a “computer readable medium” may be any apparatus that can contain, store, communicate, propagate, or transmit a program for use by or in connection with an instruction execution system, apparatus, or device. More specific examples (non-exhaustive list) of the computer readable media include: electrical connections (electronic devices) with one or more wirings, portable computer disk cases (magnetic devices), random access memory (RAM), read-only memory (ROM), erasable and editable read-only memory (EPROM or flash memory), fiber optic devices, and portable optical disk read-only memory (CDROM). In addition, the computer readable medium may even be a paper or other suitable medium on which the program can be printed, because the program can be obtained electronically by, for example, optical scanning of the paper or other medium, followed by editing, interpreting or other suitable processing if necessary, and then stored in a computer memory.

It should be understood that each part of the present application may be implemented by hardware, software, firmware, or a combination thereof. In the above embodiments, multiple steps or methods may be implemented by software or firmware stored in a memory and executed by a suitable instruction execution system. For example, if the multiple steps or methods are implemented in hardware, as in another embodiment, it may be implemented by using any one or a combination of the following techniques known in the art: discrete logic circuits with logic gate circuit for realizing logic function of data signal, special integrated circuits with suitable combination logic gate circuit, programmable gate arrays (PGA), field programmable gate arrays (FPGA), etc.

It will be understood by those of ordinary skills in the art that all or some of the steps in the method embodiments described above may be accomplished by a program to instruct the associated hardware. Said program may be stored in a computer readable storage medium and includes one or a combination of the steps of the method embodiments when executing.

In addition, all the functional units in the embodiments of the present application can be integrated in one processing module, or each of the units can be an individual unit, or two or more units can be integrated in one module. The integrated module described above can be implemented as hardware or can be implemented as a software function module. When the integrated module is implemented as a software function module and is sold or used as an independent product, the integrated unit can be stored in a computer readable storage medium.

The aforementioned storage medium may be a read-only memory, a magnetic disk, or an optical disk. Although the embodiments of the present application have been shown and described above, it can be understood that the above embodiments are exemplary and should not be understood as limitations on the present application. Those skilled in the art may change, modify, replace and transform the above embodiments within the scope of the present application.

1. An animation display method, comprising:
acquiring, when it is detected that a user opens an input method interface, a gravity sensing information of a user device;
determining, according to the gravity sensing information, a displacement of a three-dimensional element in a first background picture, wherein the first background picture is a background picture of the input method interface;
displaying, according to the displacement of the three-dimensional element, an animation of the first background picture.

2. The method of claim 1, wherein the method further comprises:
displaying an animation of the first background picture when it is detected that the user clicks keys on the input method interface.

3. The method of claim 2, wherein, the step of displaying an animation of the first background picture when it is detected that the user clicks keys on the input method interface includes:
determining, when it is detected that the user clicks a target key among the keys on the input method interface, a display style of the first background picture corresponding to the target key;
displaying, according to the display style corresponding to the target key, an animation of the first background picture.

4. The method of claim 1, wherein the method further comprises:
acquiring first identification information of the first background picture;
searching a first audio file corresponding to the first identification information from a preset voice library, the preset voice library includes a correspondence between identification information and an audio file;
playing, when an animation of the first background picture is displayed, the first audio file;
or
wherein the method further comprises:
determining a first display duration of the animation of the first background picture;
searching a second audio file corresponding to the first display duration from a preset voice library, the preset voice library includes a correspondence between a display duration and an audio file;
playing, when an animation of the first background picture is displayed, the second audio file.

5. (canceled)

6. The method of claim 2, wherein the method further comprises:
acquiring a first click frequency at which the user clicks keys on the input method interface;
searching a third audio file corresponding to the first click frequency from a preset voice library, the preset voice library includes a correspondence between a click frequency and an audio file;
playing, when an animation of the first background picture is displayed, the third audio file;
or
wherein, after displaying an animation of the first background picture, the method further comprises:
acquiring an accumulated duration elapsed after the user stops clicking a key on the input method interface;
stopping, when the accumulated duration exceeds a first threshold, displaying the animation of the first background picture.

7. (canceled)

8. The method of claim 1, wherein, after displaying an animation of the first background picture according to the displacement of the three-dimensional element, the method further comprises:
acquiring text information edited by the user on the input method interface;
displaying, according to a semantic feature of the text information, an animation of the first background picture.

9. The method of claim 1, wherein the gravity sensing information comprises a rotational angular velocity;
after displaying an animation of the first background picture according to the displacement of the three-dimensional element, the method further includes:
determining whether the rotational angular velocity exceeds a second threshold;
selecting, when the rotational angular velocity exceeds the second threshold, a second background picture from a background picture library;
replacing the background picture of the input method interface with the second background picture.

10. The method of claim 9, wherein, the step of selecting a second background picture from a background picture library when the rotational angular velocity exceeds the second threshold, comprises:
displaying prompt information when the rotational angular velocity exceeds the second threshold, the prompt information is configured for prompting the user to determine whether to replace the background picture of the input method interface;
receiving a confirmation instruction input by the user for the prompt information;
selecting, according to the confirmation instruction, a second background picture from a background picture library.

11. The method of claim 1, wherein, the step of displaying an animation of the first background picture according to the displacement of the three-dimensional element comprises:
determining a moving distance of the displacement of the three-dimensional element;
displaying, according to the moving distance, an animation of the first background picture.

12. An animation display apparatus, comprising:
an acquiring module, configured for acquiring, when it is detected that a user opens an input method interface, a gravity sensing information of a user device;
a determination module, configured for determining, according to the gravity sensing information, a displacement of a three-dimensional element in a first background picture, wherein the first background picture is a background picture of the input method interface;
a display module, configured for displaying, according to the displacement of the three-dimensional element, an animation of the first background picture.

13. The apparatus of claim 12, wherein the display module is further configured for:
displaying an animation of the first background picture when it is detected that the user clicks keys on the input method interface.

14. The apparatus of claim 13, wherein, the determination module is further configured for determining, when it is detected that the user clicks a target key among multiple keys on the input method interface, a display style of the first background picture corresponding to the target key;
the display module is further configured for displaying, according to the display style corresponding to the target key, an animation of the first background picture.

15. The apparatus of claim 12, wherein the apparatus further comprises a searching module, configured for acquiring first identification information of the first background picture, searching a first audio file corresponding to the first identification information from a preset voice library, the preset voice library includes a correspondence between identification information and an audio file;
the display module is further configured for playing, when an animation of the first background picture is displayed, the first audio file;
or
wherein the apparatus further comprises a searching module, the searching module is configured for determining first display duration of the animation of the first background picture, searching a second audio file corresponding to the first display duration from a preset voice library, the preset voice library comprises a correspondence between display duration and an audio file;
the display module is further configured for playing, when an animation of the first background picture is displayed, the second audio file.

16. (canceled)

17. The apparatus of claim 13, wherein, the apparatus further comprises a searching module, configured for acquiring a first click frequency at which the user clicks keys on the input method interface; searching a third audio file corresponding to the first click frequency from a preset voice library, the preset voice library includes a correspondence between a click frequency and an audio file;
the display module is further configured for playing, when an animation of the first background picture is displayed, the third audio file;
or
wherein, the acquiring module is further configured for acquiring an accumulated duration elapsed after the user stops clicking a key on the input method interface;
the display module is further configured for stopping, when the accumulated duration exceeds a first threshold, displaying the animation of the first background picture.

18. (canceled)

19. The apparatus of claim 12, wherein,
the acquiring module is further configured for acquiring text information edited by the user on the input method interface;
the display module is further configured for displaying, according to a semantic feature of the text information, an animation of the first background picture.

20. The apparatus of claim 12, wherein the gravity sensing information comprises a rotational angular velocity;
the determination module is further configured for determining whether the rotational angular velocity exceeds a second threshold, and selecting, when the rotational angular velocity exceeds the second threshold, a second background picture from a background picture library;
the display module is further configured for replacing the background picture of the input method interface with the second background picture.

21. The apparatus of claim 20, wherein, the determination module is further configured for displaying prompt information when the rotational angular velocity exceeds the second threshold, the prompt information is configured for prompting the user to determine whether to replace the background picture of the input method interface;
receiving a confirmation instruction input by the user for the prompt information; and
selecting, according to the confirmation instruction, a second background picture from a background picture library.

22. The apparatus of claim 12, wherein the display module is further configured for:
determining a moving distance of the displacement of the three-dimensional element;
displaying, according to the moving distance, an animation of the first background picture.

23. An electronic device, comprising: a processor, a memory, a communication interface and a bus;
the processor, the memory and the communication interfaces are connected and communicate with each other via the bus;
the memory stores executable program codes;
the processor runs a program corresponding to the executable program codes by reading the executable program codes stored in the memory, to execute the animation display method according to claim 1.

24. A non-transitory computer readable storage medium, wherein, the computer readable storage medium stores a plurality of instructions, configured for performing the animation display method according to claim 1 when the instructions are loaded and executed by the processor.

25. (canceled)
